(19) United States
(12) Patent Application Publication
(10) Pub. No.: US 2007/0067049 A1
(43) Pub. Date: Mar. 22, 2007

(54) Method and apparatus for robust shape filter generation

(75) Inventors: Li Zhou, Cupertino, OK (US); Eduardo A. Misawa, Stillwater, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: THE BOARD OF REGENTS FOR OKLAHOMA STATE UNIVERSITY

(21) Appl. No.: 11/385,064

(22) Filed: Mar. 21, 2006

Related U.S. Application Data
(60) Provisional application No. 60/663,639, filed on Mar. 21, 2005.
(60) Provisional application No. 60/663,795, filed on Mar. 21, 2005.
(60) Provisional application No. 60/663,796, filed on Mar. 21, 2005.

(51) Int. Cl. G05B 13/02

(52) U.S. Cl. 700/28

(57) ABSTRACT

According to a preferred aspect of the instant invention, there is provided a system and method of robust control profile generation which suppresses one or some resonant modes in a flexible dynamic system. This robust control profile is a smooth function which can be used as a velocity profile, or as a shape filter to an arbitrary control command. The robustness can be arbitrarily improved. The robustness brings about a smoother profile. The technique can be applied to both open-loop and closed-loop systems. As a consequence of the use of the instant invention, the movement of a flexible arm that is performed according to this sort of function will be one that has minimal or reduced residual vibration after it has reached its destination.

### RELATED APPLICATIONS

This application claims the benefit of U.S. Provisional Patent Application Ser. No. 60/663,796, 60/663,639, and 60/663,795 all filed on Mar. 21, 2005, the disclosures of which are incorporated herein by reference as if fully set out at this point. This application is further co-filed and copending with U.S. patent application No.______, the disclosure of which is incorporated by reference.

### STATEMENT REGARDING FEDERALLY SPONSORED RESEARCH

The Government of the United States of America has certain rights in this invention pursuant to Grant No. CMS-9978748 awarded by the National Science Foundation.

### TECHNICAL FIELD

This invention relates to the general subject of suppression of unwanted resonant dynamics in a flexible dynamic system and, as a specific example of an application of the instant invention, suppression of unwanted resonant dynamics in a disk drive arm.

### BACKGROUND OF THE INVENTION

The control of the motion of flexible structures has been a topic of research interest since at least the 1970's, when the control of a flexible manipulator arm was widely studied. Approaches based on modal analysis and closed-loop feedback control of flexible manipulator arm, feedback closed-loop control of flexible manipulator arms with distributed flexibility, etc. were all investigated. However, often the suggested approach was essentially to move slowly to the desired position and then wait for residual vibrations in the arm to cease before, e.g., actually beginning to read from disk. Additionally, feedback and feed forward control methods (the latter being known as “input command shaping”) have both been studied. Input command shaping involves choosing an appropriate shape of the input command for either an open-loop system or closed-loop system so that the system vibrations at the end of the move are reduced. Generally, these techniques include shaped function synthesis, open-loop optimal control, impulse shaping filters, and system-inversion-based motion planning. Note that a great deal of additional information pertaining to the state of the prior art, as well as further technical discussions related to the instant invention, may be found in the Ph.D. dissertation “Robust Vibration Suppression Control Profile Generation”, by Li Zhou, May 2005, Oklahoma State University, the disclosure of which is incorporate by reference as if fully set out at this point.

Of course, and as a specific example, flexible structures such as high-speed disk drive actuators require high precision positioning under tight time constraints. Whenever a fast motion is commanded, residual vibration in the flexible structure is induced, which tends to increase the settling time. One solution is to design a closed-loop control to damp out vibrations caused by the command inputs and disturbances to the plant. However, the resulting closed-loop damping ratio may still be too slow to provide an acceptable settling time. Also, the closed-loop control is not able to compensate for high frequency residual vibrations which occur beyond the closed-loop bandwidth. An alternative approach is to develop an appropriate reference trajectory that can minimize the excitation energy imparted to the system at its natural frequencies. Generally, these techniques include shaped function synthesis, open-loop optimal control, impulse shaping filters, and system-inversion-based motion planning.

One prior art approach that involves shaped function synthesis utilizes a finite Fourier series expansion to construct forcing functions to attenuate the residual dynamic response for slewing a flexible beam. However, the response spectrum envelope is made small only in a limited region. Also the forcing functions are sensitive to the control system. Another prior art approach utilizes a performance index which reflects the concern for the accuracy of the terminal boundary conditions to the changes in mode eigen-frequencies. However, the control inputs are often difficult to calculate, and only a few modes are considered. More recently, an approach has been suggested that utilizes a near minimum-time input with shape control weighting functions. Others have shown that control waveforms can be optimized using a Laplace domain synthesis technique. But the control inputs need to be assumed through ajudicious choice.

Those of ordinary skill in the art will recognize that none of the methods discussed above consider all of the resonance modes, which in reality may be infinite in number. Also, the modes' responses change drastically due to resonance modeling uncertainty. To overcome the resonance frequency variation, some prior art approaches have utilized a robust vibrationless control solution derived for an enlarged multi-degree-of-freedom system that has some virtual frequencies within the range of the varying natural frequencies. In that same vein, others have sought to utilize a forcing function that comprises a series of ramped sinusoids for one nominal resonance model.

More recently, a frequency-shaped cost functional whose weighting function is represented by a first order and second-order high-pass filter in the design of vibrationless access control forces has been utilized. The control forces have small frequency components in the high frequency region, but the decay rate in the frequency domain depends on the shape of the weighting function. Other prior art approaches have utilized an access control called SMART (Structural Vibration Minimized Acceleration Trajectory) for hard disk drives. The access formula is derived from the minimum-jerk cost function where the SMART state values (position, velocity, and acceleration) are expressed using time polynomials. But the jerk cost function has no direct relationship to the residual vibration.

Optimal control approaches have also been studied to generate an input command for a flexible dynamic system. Typically, an objective function is selected and subsequently minimized. For example, with the so-called Bang-Bang Principle, the time-optimal commands must be piecewise constant functions of time and the constants are solely determined by the actuator maximum and minimum power limits. Although it is easy to generate the time-optimal command input for a double integrator system, it is not easy to derive the time-optimal command for a system in which the order is greater than two. Other types of optimal control select different objective functions, for example, integral squared error plus some control penalty. Generally, these objective functions do not explicitly include a direct measure of both the move time and the unwanted resonant dynamics. These profiles are therefore very sensitive to unmodeled flexible dynamics.

The posicast control method uses a kind of set point shaping. This method breaks a step input into two smaller steps, one of which is delayed in time. The delayed input results in a vibration cancellation for a precisely known resonance. So the posicast can reduce the settling time of system response to a step input. As another example, in some instances instead of using two impulses to generate the delayed input, input shapers use three or more impulses to generate a delayed input. The more impulses used, the more robustness is achieved. One of the disadvantages of this technique is that the input shapers induce a delay to the system response. The robustness of the input shapers can cause additional delays to the system response. The more impulses that are used, the more time delay that may be induced. It may also be difficult or impossible to design an input shaper to accommodate all of the resonant modes in a complex flexible structure

Finally, some prior art approaches have attempted to address the problem of open-loop control of the end-point trajectory of a single-link flexible arm by an inverse dynamic solution. For example, a number of basic sinusoidal time functions and their harmonics have been used in trajectory synthesis. As still another example, some prior art approaches have determined the command function of the system by means of a non-causal system inversion with a continuous derivative of an arbitrary order. Of course, in such an approach a precise model of the system is generally required. Another disadvantage of these system-inversion-based motion planning techniques is that the smooth motion and robustness is achieved at the expense of long move times.

As has been indicated above, although any number of prior art references have considered the problem, there remains no satisfactory solution to the problem of minimizing unwanted resonant dynamics in a flexible dynamic system. Accordingly, it should now be recognized, as was recognized by the present inventors, that there exists, and has existed for some time, a very real need for a method that would address and solve the above-described problems.

Before proceeding to a description of the present invention, however, it should be noted and remembered that the description of the invention which follows, together with the accompanying drawings, should not be construed as limiting the invention to the examples (or preferred embodiments) shown and described. This is so because those skilled in the art to which the invention pertains will be able to devise other forms of this invention within the ambit of the appended claims.

### SUMMARY OF THE INVENTION

According to a preferred aspect of the instant invention, there is provided a system and method of generating a robust control profile which suppresses one or some resonant modes in a flexible dynamic system. This robust control profile is a smooth function which can be used as a robust velocity profile, or as a robust shape filter to an arbitrary control command. The instant invention is preferably used to generate a robust vibration suppression profile for any given resonant mode, no matter where the resonant frequency falls in the spectrum. More particularly, a general method is taught for suppressing a particular mode even if its frequency location would make other approaches (e.g., concentrating the spectral power of the control profile below the smallest resonant frequency) impractical. This technique can be applied to both open-loop and closed-loop systems.

According to another aspect of the instant invention, there is provided a method substantially similar to that described above, but wherein the robustness of a control profile can be improved according to methods described hereinafter. The increased robustness brings about a smoother profile. This technique can be applied to both open-loop and closed-loop systems.

The foregoing has outlined in broad terms the more important features of the invention disclosed herein so that the detailed description that follows may be more clearly understood, and so that the contribution of the instant inventors to the art may be better appreciated. The instant invention is not to be limited, in its application, to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

Other objects and advantages of the invention will become apparent upon reading the following detailed description and upon reference to the drawings in which:

FIG. 1 illustrates the general environment of the instant invention in the context of a computer disk drive.

FIG. 2 is a functional diagram of a typical disk drive.

FIG. 3 illustrates a typical flexible mechanical system.

FIG. 4 illustrates a Bode magnitude plot of a reduced order transfer function R(s).

FIG. 5 illustrates a typical trajectory for a double integrator system.

FIG. 6 illustrates move time and settle time for a hard disk drive arm movement with open-loop control.

FIG. 7 illustrates the move time and the settle time for a hard disk drive arm movement with closed-loop control.

FIG. 8 illustrates a standard closed-loop control scheme.

FIG. 9 illustrates a model reference closed-loop control scheme.

FIG. 10 illustrates a robust forcing function generation from velocity reference wave.

FIG. 11 illustrates implementation of model reference closed-loop control with robust vibration suppression control profiles.

FIG. 12 a step position command, a non-zero start and end shape filter and the filtered position reference.

FIG. 13 illustrates a step position command, a non-smooth shape filter and the filtered position reference.

FIG. 14 illustrates the existence of a low resonance frequency mode located far from the high frequency modes in a flexible system.

FIG. 15 contains a logic flow chart that illustrates some preferred steps in the instant method.

FIG. 16 illustrates a rectangle based shape filter with ωᵢ=1, ζᵢ=0, and the robustness order n=1.

FIG. 17 illustrates a rectangle based shape filter with ωᵢ=1, ζᵢ0, and robustness order n=2.

FIG. 18 illustrates a rectangle based shape filter with ωᵢ=1, ζᵢ0, and the robustness order n=3.

FIG. 19 illustrates a rectangle based shape filter with ωᵢ=1, ζᵢ0.05, and the robustness order n=1.

FIG. 20 illustrates a rectangle based shape filter with ωᵢ=1, ζᵢ0.05 and the robustness order n=2.

FIG. 21 illustrates a rectangle based shape filter with ωᵢ=1, ζᵢ0.05, and the robustness order n=3.

FIG. 22 illustrates: Left ZVD input shaper with ωᵢ=1, ζᵢ0.05; Right: rectangle based shape filter ƒ₁[k] with ωᵢ=1, and ζᵢ0.05.

FIG. 23 illustrates: Left: ZVD input shaping sensitivity plot versus actual natural frequency; Right: rectangle based shape filter ƒ₁[k] sensitivity plot versus actual natural frequency.

FIG. 24 illustrates construction of a non-symmetric base function h[k].

FIG. 25 illustrated normalized base function h[k] and shape filter ƒ[k].

### DETAILED DESCRIPTION

While this invention is susceptible of being embodied in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

### General Enviroment of the Invention

To illustrate an exemplary environment in which presently preferred embodiments of the present invention can be advantageously practiced in the context of computer disk drives, FIG. 1 shows an exploded view of a data storage device 100. The device 100 is preferably characterized as a small form factor disc drive used to store and retrieve user data in a battery-operated, handheld mobile product such as a notebook computer or a digital camera, but such is not limiting to the scope of the claimed subject matter.

The device 100 includes a rigid environmentally controlled housing 101 formed from a base deck 102 and a top cover 104. A spindle motor 108 is mounted within the housing 101 to rotate a number of data storage media 110 (in this case, two) at a relatively high speed.

Data are stored on the media 110 in an array of concentric tracks (not shown), having a nominal radial density of about 100K tracks/inch (in). The tracks are accessed by a corresponding array of data transducing heads 112 (transducers). The heads 112 are supported by an actuator 114 and moved across the media surfaces by application of current to a voice coil motor, VCM 116. A flex circuit assembly 118 facilitates communication between the actuator 114 and control circuitry on an externally mounted printed circuit board, PCB 120.

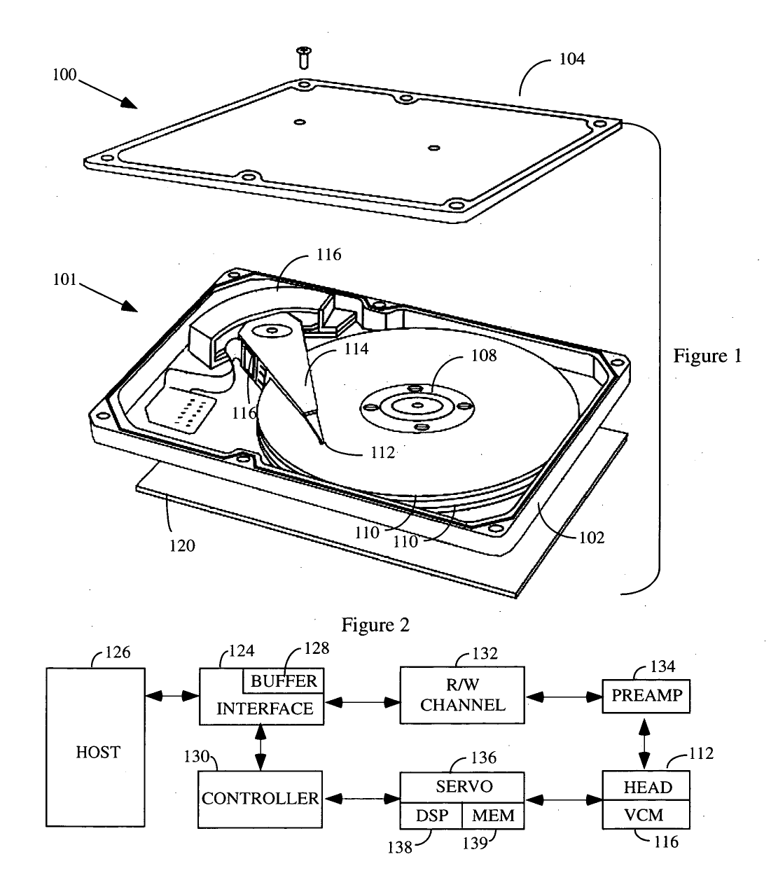

As shown in FIG. 2, the control circuitry preferably includes an interface circuit 124 which communicates with a host device 126 using a suitable interface protocol (fibre channel, SAS, SCSI, etc.). The interface circuit 124 includes a buffer (cache memory) 128 for the temporary storage of data being transferred to or from the media 110. A controller 130 provides top level control for the device 100 and is preferably characterized as a programmable, general purpose processor with suitable programming to direct the operation of the device 100.

A read/write channel 132 encodes data to be written to the media 110 during a write operation and reconstructs transduced feedback signals from the media 110 to reconstruct previously stored data during a read operation. A preamplifier/driver circuit (preamp) 134 provides head selection circuitry and conditions signals provided to and received from the heads 112.

A servo circuit 136 provides closed loop positional control for the heads 112. The servo circuit 136 preferably includes a digital signal processor (DSP) 138 which operates in accordance with associated programming and data in memory (MEM) 139 and in response to control inputs from the top level controller 130. A two processor system is preferred, but not required.

During a seek operation, the servo circuit 136 moves a selected head 112 from an initial track to a destination track on the associated media surface. Generally, the seek operation is not concluded until the head has successfully settled onto the destination track and the servo circuit is able to follow that track to allow the initiation of data access operations therewith.

It is desirable to carry out seeks in a minimum amount of time in order to maximize overall data throughput rates with the host 126. However, system resonances can adversely impact seek times, since the undesired excitation of such resonances during the movement of the actuator 118 can lengthen the settling time as the head 112 oscillates about the destination track.

### Discussion of the Preferred Embodiments

Turning now to a discussion of the instant invention, the instant invention is broadly based on the observation that if a forcing function is selected to have a zero or near-zero value in its frequency spectrum at one or more locations corresponding to resonance frequencies of the flexible structure, then the residual vibrations that would otherwise be observed after the move will be greatly attenuated or eliminated.

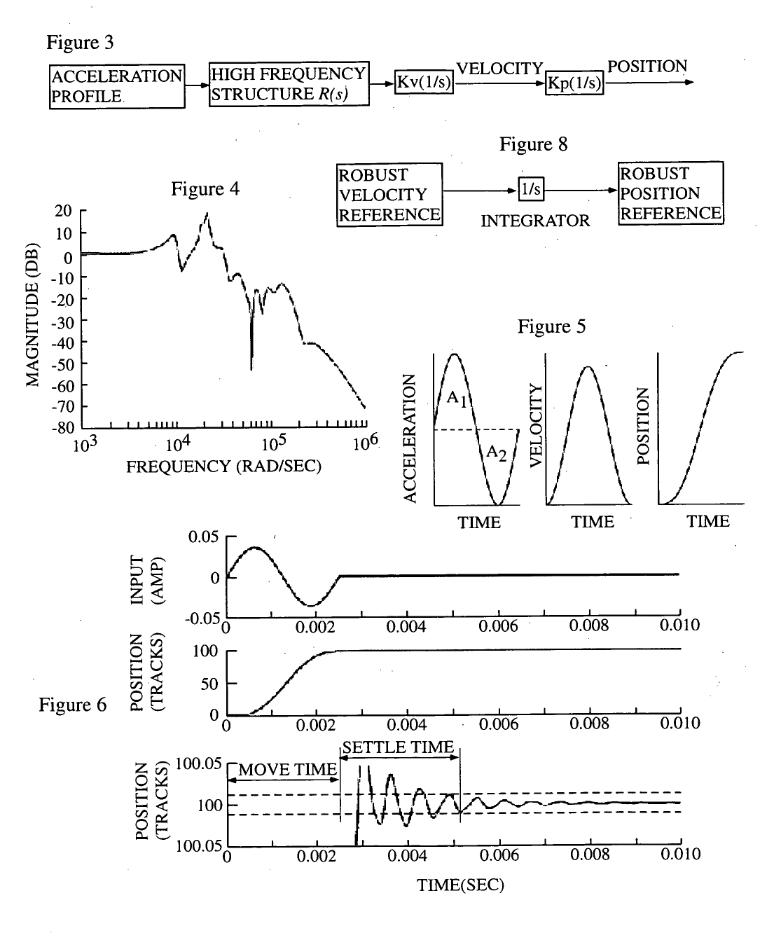

FIG. 3 shows a typical flexible mechanical system level block diagram, where 1/s is an integrator, Kv is a velocity constant gain, and Kp is a position constant gain. The high frequency modes can be described as a transfer function R(s) which has a possibly infinite number of lightly damped resonant structures. FIG. 4 shows a Bode magnitude plot of a typical reduced order (28th order) transfer function R(s). This function was empirically derived from the flexible arm of an open disk drive. As can be readily seen by reference to FIG. 4, the resonance modes change drastically due to variation of the mode parameters. On the Bode plot, the frequency response peaks may shift horizontally in frequency and vertically in amplitude due to, for example, environmental variations such as temperature changes.

Note that a primary goal of the instant invention is to find a fast input trajectory, under some physical constraint, that has the least possible residual vibration. To that end, the approach used herein will be to consider the movement of the rigid mode described by the double integrator

$$\frac{1}{{s}^{2}} ,$$

from acceleration to position. For purposes of clarity in the discussion that follows, the constant gains Kv and Kp will be assumed to be equal to unity and will not be considered hereinafter. Those of ordinary skill in the art will recognize how the instant invention can readily be modified to accommodate those constants if desired.

A typical trajectory for a double integrator system is shown in FIG. 5. Notice that, in order to secure a zero velocity status of the rigid mode after a move, the area of A₁ should be equal to the area of A₂. Physically, if a finite move time is imposed, a flexible beam will be accelerated during the first part of the move (A₁) and then decelerated during the second part (A₂). However, and as is well known to those of ordinary skill in the art, due to the potentially infinite number of resonant modes, the final position cannot, in practice, be maintained immediately after movement ceases because of the on-going residual vibrations which may take some time to subside to an acceptable level. It is this residual vibration that the instant invention is designed to minimize.

The phrase “move time” refers to the time duration of the feed forward control input, such as acceleration, current, or voltage. “Settle time” will be taken to mean the length of time following the end of the move that is required to achieve the settle criterion, for example ±5% tracking error. Seek time is the sum of the move time and the settle time. FIG. 6 illustrates these concepts for an exemplary a hard disk drive arm movement. The top plot is the current input signal, the middle plot is the resultant position signal, and the bottom plot shows the position signal near the target track. In this instance, the move time is about 2.5 msec. Because of the resonant structure in the flexible system, the position signal cannot settle down immediately after the move. In FIG. 6, the settle time is about 2.5 msec assuming a ±1% tracking error criterion. A further objective of the instant invention is to minimize the seek time, assuming, of course, that the context in which the instant invention is applied is disk drive technology.

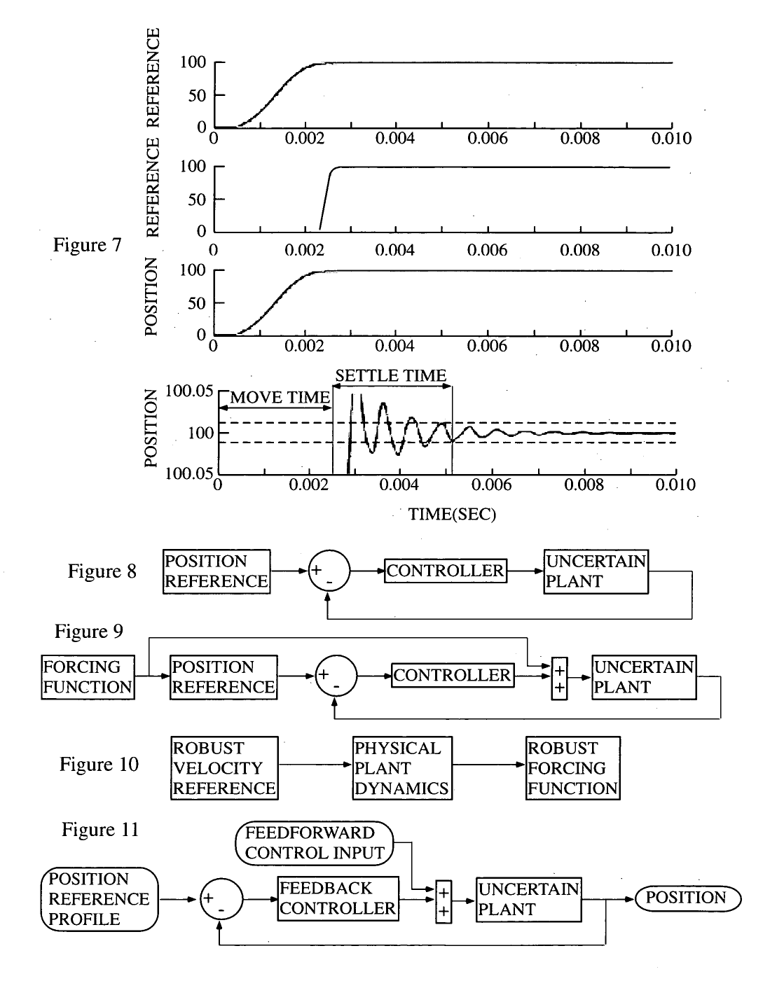

The same concepts apply to closed-loop control. FIG. 7 illustrates a typical move/settle time for a hard disk drive arm movement with closed-loop control. The top two plots are the reference position movement profile and the bottom two plots show the real position signals. In this instance, the move time of the flexible arm is 2.5 msec. Due to the resonant structure in the flexible system, the position signal cannot settle down immediately after the move and the settle time is about 2.5 msec with ±1% tracking error criterion.

Generally speaking, it should be noted that a position reference input can be generated in two preferred ways. First, it can be computed as the integral of a robust vibration suppression velocity profile as shown, for example, in FIG. 8. In this example, since the velocity profile is selected to be a smooth trajectory that starts and ends at zero, the resultant position reference will similarly have a smooth trajectory.

Alternatively, the position reference input can be generated from a step movement command through a finite support filter, ƒ(t), 0≦t≦T, where T is the time duration of the finite support filter. To guarantee that the filtered command reaches the same set point as the step movement command, the integral of ƒ(t) will be imposed to be equal to unity, i.e.,
∫₀^{Tƒ(}t)dt=1.
If the original command s(t) is a step reference, say,
s(t)=1, t≧0,
then the filtered command p(t) reaches the original command s(t)=1, t≧0, immediately at the time duration T of the finite support filter, i.e.,
p(t)=s(t), t≧T

This finite support filter ƒ(t), 0≦t≦T, that can generate a vibration suppression position reference profile is called a vibration suppression shape filter, or simply a shape filter. In the discrete-time case, if the finite impulse response shape filter is ƒ[k], 0≦k≦M, the requirement that the integral of ƒ(t) is equal to unity has the following discrete-time analog:

$${\sum }_{k = 0}^{M} f [ k ] = 1$$

Similarly, a normalized robust vibration suppression velocity profile can be used to generate a corresponding reference position profile. Normalization is typically applied to make the velocity profile satisfy the unit integral constraint. More particularly, given a robust vibration suppression velocity profile, v(t), 0≦t≦T, a vibration suppression shape filter ƒ(t) can be generated via the following calculation:

$$f ( t ) = \frac{v ( t )}{{\int }_{0}^{T} v ( t ) ⅆ t} .$$

One advantage of using this sort of shape filter is that the filter itself is a robust vibration suppression velocity profile, so it can be used to generate a smooth vibration suppression position reference.

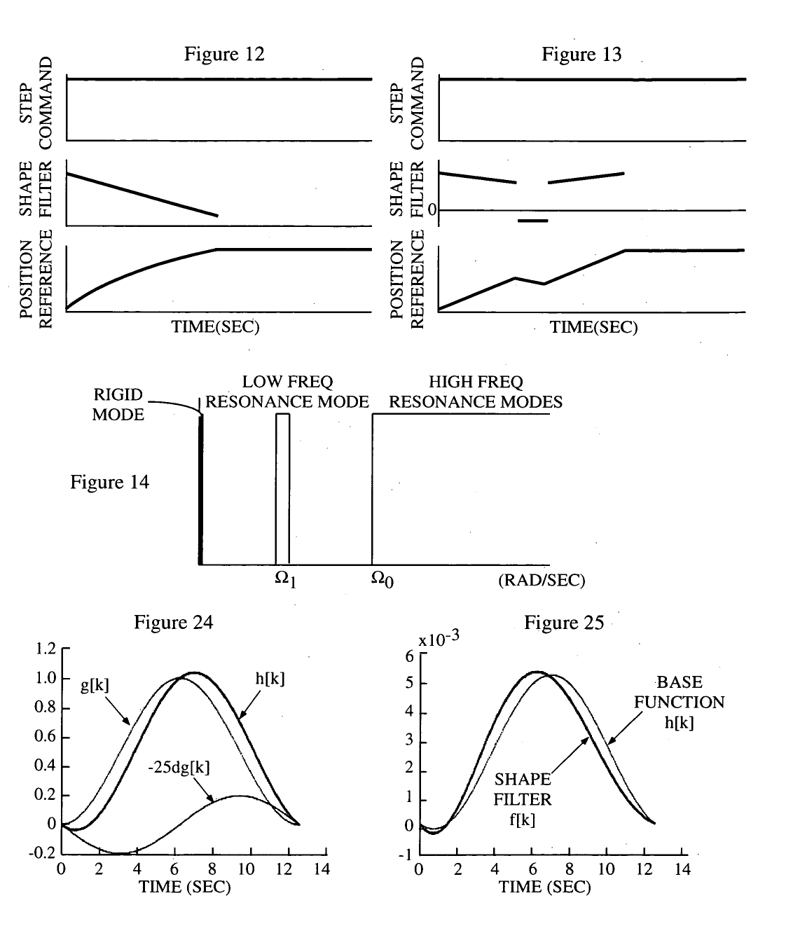

Those of ordinary skill in the art will recognize that a shape filter does not necessarily need to start and end at zero. By way of example, FIG. 12 shows a step position command, a typical shape filter that has non-zero values at the start and end, and the filtered position reference. Although the shape filter smoothly changes from the start to the end, the initial value at time zero and the final value of the shape filter are not zero.

Furthermore a shape filter can also be a non-smooth function. FIG. 13 shows a step position command, a typical non-smooth shape filter, and the filtered position reference. It shows that the shape filter function is not smooth from the start to the end.

The robust vibration suppression position reference generated from a step command s(t)=S·1(t) through a shape filter, ƒ(t), 0≦t≦T, can also be generated from the integral of a scaled shape filter S·ƒ(t), 0≦t≦T, since

$$\begin{matrix}s ( t ) * f ( t ) = {\int }_{0}^{t} s ( t - τ ) f ( τ ) ⅆ r , \\ = {\int }_{0}^{t} S \cdot 1 ( t - τ ) f ( τ ) ⅆ τ , \\ = {\int }_{0}^{t} S \cdot f ( τ ) ⅆ τ .\end{matrix}$$

Here, “*” is the convolution operator. Similarly, the robust vibration suppression position reference generated from a step command s(t)=S·1(t) through a discrete-time shape filter, ƒ[k], 0≦k≦M, can also be generated from the integral of a scaled shape filter S·ƒ[k], 0≦k≦M.

The vibration suppression shape filters can also be used to shape other control profiles. The control profile here refers to the trajectories in the control system, such as acceleration, velocity, or position signals.

Note that in the co-pending application by the instant inventors identified previously, the approach is to suppress all of the higher frequency (≧Ω₀) resonance modes. However, in practice, a lower resonance frequency mode may exist which is located far from the high frequency resonance modes as is schematically illustrated in FIG. 14. The occurrence of lower frequency resonant modes may be attributable to any number of hardware-related factors. For example, the lower frequency resonant modes of the flexible arm in a hard disk drive might include the transient interaction between the flexible arm and the connected parts, such as the flexible cable.

However, if an approach that is based on suppressing all frequencies above the lowest resonance frequency is pursued in a scenario like that illustrated in FIG. 29, the time duration of the shape filter will be inefficiently increased. As a consequence, it is a goal of the instant invention to generate a robust vibration suppression profile that is designed to eliminate a given specific resonant mode.

FIG. 8 contains a schematic diagram of a standard closed-loop control scheme. The position reference is the reference input to the closed-loop system. The robust position reference can be generated from the robust velocity reference or a step movement command through a vibration suppression shape filter has been demonstrated previously.

FIG. 9 contains a schematic diagram of another kind of closed-loop control scheme. In this control scheme, the forcing function signal is sent directly to both the uncertain plant and a reference model of the plant. The controller takes as its input the tracking error, which is the difference of the real position and the position reference generated by the reference model. The robust forcing function can be generated from a robust velocity profile through the physical system dynamics as shown in FIG. 10.

In practice, the position reference from the reference model may be saved in a table and directly used as a reference input as shown in FIG. 11.

Turning now to a detailed discussion of the instant invention, the inventors have discovered the following central results with respect to residual motion of undamped and damped mechanical systems as they relate to residual vibrations in flexible systems, which results are key to the invention.

First, in the case of an undamped system, given a forcing function u(t), 0≦t≦T₀, the residual vibration of the i^{th} mode immediately after a move time T₀ will be eliminated if and only if the magnitude spectrum of the forcing function has zero value at the natural frequency ωᵢ, i.e., U(ωᵢ)=0.

Additionally, the instant inventors have discovered that robustness can be further improved if higher order derivatives of U(ω) with respect to ω at ω=ωᵢ are forced to be equal to zero, i.e.,

$$\frac{{ⅆ}^{k} U ( ω )}{ⅆ {ω}^{k}} {\vert}_{ω = {ω}_{i}} = 0 , k = 1 , … , n .$$

The previous constraints on the value of the derivatives of U(ω) tend to flatten its spectrum at ω=ωᵢ. This, in turn, means that the values of |U(ω)| around ω=ωᵢ will tend to be close to the value of |U(ωᵢ)| which is zero at those points.

The second important result and key aspect of the instant invention is made with reference to a damped mechanical system. In this case, given a forcing function u(t), 0≦t≦T₀, the residual vibration of the i^{th} mode immediately after the move time T₀ is eliminated if and only if the magnitude spectrum of uₑ(t)=e^{ζ}^{ᵢ}^{ω}^{ᵢ}^{t}u(t), 0≦t≦T₀, has zero value at the damped natural frequency ω_{di,}, i.e., Uₑ(ω_{di})=Uₑ(\sqrt{1−ζᵢ²}ωᵢ)=0. For details of the derivation of this, and the previous, result see Zhou's Ph.D. thesis, cited previously.

One consequence of the result stated in the previous paragraph is that, in the case of a damped mechanical system, the mere fact that the spectrum of the forcing function u(t) has zero value in its spectrum at a resonance frequency is insufficient to guarantee that residual vibrations due to that mode been eliminated. Instead, the function uₑ(t)=e^{ζ}^{ᵢ}^{ω}^{ᵢ}^{t}u(t) must have a zero at a spectral value corresponding to the damped natural frequency ω=ω_{di}=\sqrt{1−ζᵢ²}ωᵢ.

Note that robustness can be further improved if the higher order derivatives of Uₑ(ω) with respect to ω at ω=ω_{di} are set to zero, i.e.,

$$\frac{{ⅆ}^{k} {U}_{e} ( ω )}{ⅆ {ω}^{k}} {\vert}_{ω = {ω}_{di}} = 0 , k = 1 , … , n ,$$

which tends to flatten the spectrum of Uₑ(ω) at ω=ω_{di} as described previously.

The preceding results have an important consequence with respect to the design of robust control profiles and shape filters. First, if h(t) is a proposed robust control profile candidate for use with resonance frequencies ω_{di} and with a system with damping ratio ζᵢ., then the ratio h(t)/exp[ζᵢωᵢt] provides a preferred control function for purposes of eliminating the residual vibration caused by the selected resonant mode.

Further, the function h(t)/exp[ζᵢωᵢt] with the constraint

$${\int }_{0}^{{T}_{0}} \frac{h ( t )}{{ⅇ}^{{ζ}_{i} {ω}_{i} t}} ⅆ t = 1$$

is a preferred vibration suppression shape filter that can be used to filter an arbitrary control profile, and the resulting shape control profile will be expected to attenuate or eliminate the residual vibration caused by the resonant mode with the natural frequency c)i and the damping ratio ζᵢ.

Finally, if there is a candidate control profile with the property that H(ω_{di})=0, then it can be improved by the following filter operation:

$${h}_{n} ( t ) = {\int }_{0}^{t} {h}_{n - 1} ( t - τ ) {h}_{1} ( τ ) ⅆ τ , n \geq 2 ,$$

where

$${h}_{1} ( t ) = \frac{h ( t )}{{ⅇ}^{{ζ}_{i} {ω}_{i} t}}$$

and the resultant spectrum of hₙ(t) is Hₙ(ω)=H₁(ω)ⁿ.

Here, the robust control profile or shape filter h₁(t) is said to have a robustness order 1. The robust control profile or shape filter hₙ(t) generated from previously filter operation in is said to have the robustness order n.

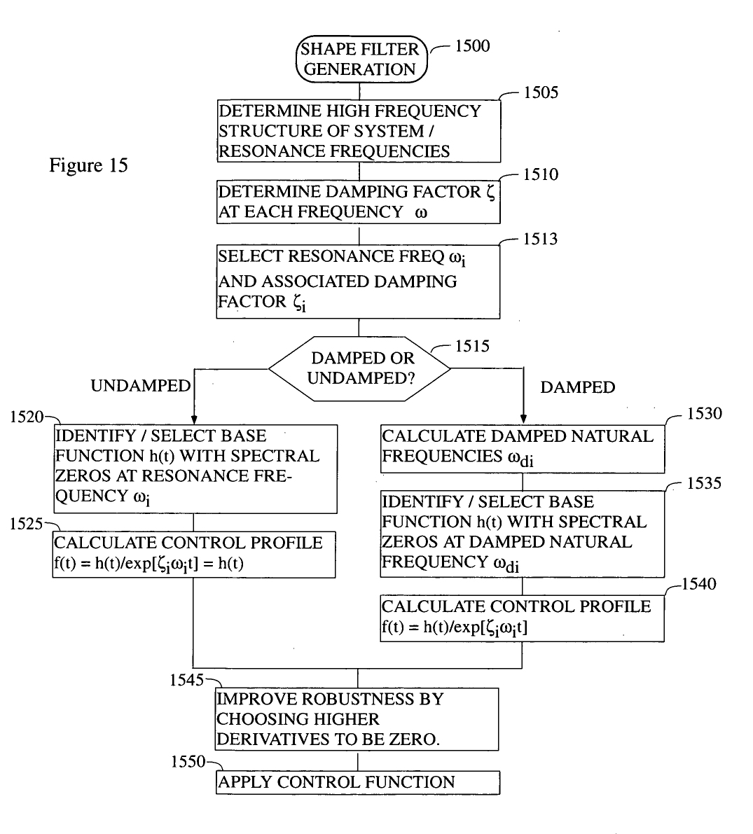

FIG. 15 contains a logic diagram that summarizes some of the key steps in the foregoing. Shape filter generation method 1500 preferably begins by determining the high frequency structure of the system in question (step 1505). As has been indicated elsewhere herein, that system will be understood to be a disk drive arm for purposes of specificity, but could alternatively be any number of other devices including robot arms, articulated (or not) precision engineering machinery, etc. The determination of the high frequency structure of the system will preferably also include determination of the resonance frequencies (oi, although these frequencies may or may not be in the high frequency part of the spectrum. (See, for example, FIG. 14 and the discussion associated therewith).

As a next preferred step, the damping factors ζᵢ will preferably be determined at each frequency ωᵢ or, in some embodiments, the damping factors will be determined at only select ones of the resonance frequencies (step 1510). Those of ordinary skill in the art will understand that the damping factors may potentially be different for each frequency.

Next, a specific resonance frequency will be selected for removal/control (step 1513). Preferably, this will be a resonance frequency that is particularly trouble some and which is found at a lower frequency. That being said, the instant invention could potentially be applied to resonance frequencies that are located in any part of the spectrum.

Those of ordinary skill in the art will recognize that in some cases the damping factor will be zero or near to that value, in which case the system is for all practical purposes undamped at that resonance frequency. Thus, a determination will be made at step 1515 whether or not the system is damped at the selected resonance frequency.

In the event that the system is effectively undamped at the selected frequency, the left arm of decision item 1515 will be taken as is generally indicated in FIG. 15. As a next step, a candidate base function will be selected (step 1520). This base function will preferably have a spectral zero (or near zero) at the selected resonance frequency ωᵢ. Although the candidate base function might be selected in many ways, in one preferred embodiment a rectangular base function will be used, the length of the base function being chosen such that one of the many zeros of its Fourier transform spectrum coincides at least approximately with the selected resonance frequency. As is explained more fully below, the instant inventors tend to prefer the use of a rectangular base function because it results in the shortest time duration filter of all base functions currently known to the inventors.

As a next preferred step 1525, the control profile will be calculated according to the equations introduced previously. However, in the circumstance that the system is undamped at the selected frequency, the candidate base function can be taken to be the control profile h(t).

Returning now to right branch of decision item 1515 (i.e., the “damped” branch) in FIG. 15, if the system is determined to be damped at the selected resonance frequency, the damped natural frequency ω_{di} will preferably be calculated for the selected resonance frequency according to the formula introduced previously (i.e., ω=ω_{di}=\sqrt{1−ζᵢ²}ωᵢ).

Next, a base function h(t) will preferably selected that has spectral (near) zeros at the damped natural frequency (step 1535). Once again, in the preferred arrangement a rectangular window will be used, with its length being chosen such that it has a spectral zero proximate to or equal to the damped natural frequency. Of course, and as was discussed in connection with Step 1520, alternative base function choices are certainly possible and well within the ability of one of ordinary skill in the art to devise.

As a next preferred step, a control profile will be calculated from the selected base function via the equation

$$f ( t ) = \frac{h ( t )}{{ⅇ}^{{ζ}_{i} {ω}_{i} t}}$$

(step 1540). Note that, although this transformation is certainly preferred, it is not essential. What is most important for purposes of the instant invention is that the base function has zeros in its spectrum at the damped natural frequencies.

In both the damped and the undamped cases, the robustness of the filter might optionally be improved (step 1545) by flattening the spectrum in the vicinity of the resonance frequency. Methods for doing this have been discussed previously (and will be discussed further below) and include, for example, setting the higher derivatives of the control profile to zero at (or near) the damped natural frequency, autocorrelation (self-correlation) of the control profile with itself, etc.

As a final step, the control function will preferably be applied (step 1550) to produce a movement of the system. Of course, those of ordinary skill in the art will recognize that the utilization of the control function might not be immediate, but could come much later. That is, in some preferred embodiments the control function will be calculated on the fly (in real time) each time a move is contemplated. This might be the case where the system takes the form of a robot arm. However, in other embodiments (e.g., a disk drive arm), multiple control functions (e.g., one for each of many possible track movement intervals) might be calculated and stored for recall as needed during a series of disk reads.

Those of ordinary skill in the art will recognize how the previous discussion can be readily expanded to cover a scenario where there are multiple low-frequency (or high frequency) resonance frequencies that must be controlled or otherwise avoided. For example, in one preferred embodiment separate control functions f₁(t) and f₂(t) will be determined that are designed to avoid/control resonant frequencies ω_{d1} and ω_{d2} (or ω₁ and ω₂ in the undamped case) respectively. As is well known to those of ordinary skill in the art, since time-domain convolution of two functions corresponds to frequency domain multiplication of their spectra, the function that results from the pair wise convolution will have spectral zeros (or near zeros) at both resonant frequencies. This suggests that convolution might be used to create a function that has zeros at both target spectral frequencies. Although the control function that is produced by convolution will be longer than either of the input functions, it will have the advantage that it should minimize vibrations at both of the problem frequencies. Obviously, the previously approach could be extended to any number of resonance frequencies.

In order to more clearly understand the implications of the previous discussion, some exemplary control profiles will be examined hereinafter.

First, consider a simple two-impulse function,

$$f ( t ) = \frac{h ( t )}{{ⅇ}^{{ζ}_{i} {ω}_{i} t}} , i . e . ,$$

$$f ( t ) = \{ \begin{matrix}{A}_{1} & if t = {t}_{1} , \\ {A}_{2} & if t = {t}_{2} , \\ 0 & otherwise .\end{matrix}$$

Since h(t)=ƒ(t)e^{ζ}^{ᵢ}^{ω}^{ᵢ}^{t}, then to guarantee H(ω_{di})=H(\sqrt{1−ζᵢ²}ωᵢ)=0, the following equations must hold.
A₁+A₂e^{ζ}^{ᵢ}^{ω}^{ᵢ}^{t}^{₂} cos(ω_{di}t₂)=0,
A₂e^{ω}^{ᵢ}^{ω}^{ᵢ}^{t}^{₂} sin(ω_{di}t₂)=0.
Here t₁ is always assumed to be zero to reduce the time duration of the shape filter. With the additional shape filter constraint, A₁+A₂=1, the resultant function ƒ(t) is given by

$$f ( t ) = \{ \begin{matrix}\frac{1}{1 + K} & if t = 0 , \\ \frac{K}{1 + K} & if t = Δ T , \\ 0 & otherwise .\end{matrix}$$

where

$$K = {ⅇ}^{\frac{{ζ}_{i} π}{\sqrt{1 - {ζ}_{i}^{2}}}} and Δ T = \frac{π}{{ω}_{di}} = \frac{π}{{ω}_{i} \sqrt{1 - {ζ}_{i}^{2}}} .$$

This vibration suppression shape filter is exactly the input shaping Zero Vibration (ZV) impulse filter. The base function of this shape filter is

$$h ( t ) = \{ \begin{matrix}1 & if t = 0 , \\ 1 & if t = Δ T , \\ 0 & otherwise .\end{matrix} \\ where \\ Δ T = \frac{π}{{ω}_{di}} = \frac{π}{{ω}_{i} \sqrt{1 - {ζ}_{i}^{2}}}$$

To improve the robustness of this profile, let ƒ₁(t)=ƒ(t), then ƒ₂(t)=∫₀^{t}ƒ₁(t−τ)ƒ₁(τ)dτ, and the resultant shape filter with robustness order n=2 is given by

$${f}_{2} ( t ) = \{ \begin{matrix}\frac{1}{1 + 2 K + {K}^{2}} & if t = 0 , \\ \frac{2 K}{1 + 2 K + {K}^{2}} & if t = Δ T , \\ \frac{{K}^{2}}{1 + 2 K + {K}^{2}} & if t = 2 Δ T , \\ 0 & otherwise .\end{matrix}$$

Of course, those of ordinary skill in the art will recognize that the previous shape filter is exactly the input shaping Zero Vibration Derivative (ZVD) impulse filter. The base function of this shape filter is

$$h ( t ) = \{ \begin{matrix}1 & if t = 0 , \\ 2 & if t = Δ T , \\ 1 & if t = 2 Δ T , \\ 0 & otherwise .\end{matrix}$$

If n=3, then ƒ₃(t)=∫₂(t−τ)ƒ₁(τ)dτ, and the resultant shape filter with robustness order n=3 is given by

$${f}_{3} ( t ) = \{ \begin{matrix}\frac{1}{1 + 3 K + 3 {K}^{2} + {K}^{3}} & if t = 0 , \\ \frac{3 K}{1 + 3 K + 3 {K}^{2} + {K}^{3}} & if t = Δ T , \\ \frac{3 {K}^{2}}{1 + 3 K + 3 {K}^{2} + {K}^{3}} & if t = 2 Δ T , \\ \frac{{K}^{3}}{1 + 3 K + 3 {K}^{2} + {K}^{3}} & if t = 3 Δ T , \\ 0 & otherwise .\end{matrix}$$

This derived shape filter is exactly the input shaping ZVDD impulse filter. The base function of this shape filter is

$$h ( t ) = \{ \begin{matrix}1 & if t = 0 , \\ 3 & if t = Δ T , \\ 3 & if t = 2 Δ T , \\ 1 & if t = 3 Δ T , \\ 0 & otherwise .\end{matrix}$$

Robustness can also be further improved by the filter operation discussed previously. The price of the robustness improvement is, predictably, that the time duration of the shape filter will be increased.

The foregoing example assumes that all the impulses are positive. In the event that one or more of the impulses are negative, the resultant negative shape filter may be shorter than the positive shape filter. However, and as is well known to those of ordinary skill in the art, negative input shapers can cause large unmodeled high frequency vibration and, as such, are not generally preferred.

Much more useful for purposes of the instant invention than impulse functions are continuous velocity functions. As an exemplary calculation, consider a robust shape filter that is generated from a rectangular window of the form:

$$h ( t ) = \{ \begin{matrix}\frac{1}{T} , & if 0 \leq t \leq T , \\ 0 , & otherwise .\end{matrix}$$

Note that a rectangular window has particular importance for purposes of the instant invention. The inventors have determined that it results in the shortest known filter duration and, as a consequence, is especially suitable where a minimal move time is desired. Further, the rectangular window has an arbitrarily large number of zeros in its spectrum and, as such, it is relatively easy to adjust its length to cause a spectral zero to coincide with a given resonance frequency. The Fourier transform of h(t) is readily shown to be given by

$$\begin{matrix}H ( ω ) = {\int }_{0}^{T} \frac{1}{T} {ⅇ}^{- j ω t} ⅆ t , \\ = \frac{1 - {ⅇ}^{- j ω T}}{j ω T} ,\end{matrix}$$

and its magnitude spectrum is

$$\begin{matrix}\vert H ( ω ) \vert = \vert \frac{1 - {ⅇ}^{- j ω T}}{j ω T} \vert , \\ = \vert \frac{sin ( ω T / 2 )}{ω T / 2} \vert .\end{matrix}$$

If

$$H ( {ω}_{di} ) = H ( \sqrt{1 - {ζ}_{i}^{2}} {ω}_{i} ) = 0 , then T = \frac{2 π}{{ω}_{di}} ,$$

which is the same time duration as the input shaping ZVD impulse filter. So a smooth shape filter, ƒ(t), can be generated according to the instant invention as follows:

$$\begin{matrix}f ( t ) = \frac{h ( t ) / {ⅇ}^{{ζ}_{i} {ω}_{i} t}}{{\int }_{0}^{∞} h ( t ) / {ⅇ}^{{ζ}_{i} {ω}_{i} t} ⅆ t} , \\ = \frac{h ( t ) / {ⅇ}^{{ζ}_{i} {ω}_{i} t}}{( 1 - {ⅇ}^{- {ζ}_{i} {ω}_{i} T} ) / ( {ζ}_{i} {ω}_{i} T )} \\ = \{ \begin{matrix}\frac{{ζ}_{i} {ω}_{i}}{1 - {ⅇ}^{- {ζ}_{i} {ω}_{i} T}} {ⅇ}^{{ζ}_{i} {ω}_{i} t} & if 0 \leq t \leq T , \\ 0 & otherwise .\end{matrix}\end{matrix}$$

When ζᵢ=0, the shape filter ƒ(t) can readily be shown to be equal to h(t) as defined above. To improve the robustness properties of this operator, the filter operation discussed previously will be applied. Let ƒ₁(t)=ƒ(t), then ƒ₂(t)=∫₀^{t}ƒ₁(t−τ)ƒ₁(τ)dτ, and the resultant shape filter with robustness order n=2 is given by

$${f}_{2} ( t ) = \{ \begin{matrix}{( \frac{{ζ}_{i} {ω}_{i}}{1 - {ⅇ}^{- {ζ}_{i} {ω}_{i} T}} )}^{2} {ⅇ}^{- {ζ}_{i} {ω}_{i} t} t & if 0 \leq t \leq T , \\ {( \frac{{ζ}_{i} {ω}_{i}}{1 - {ⅇ}^{- {ζ}_{i} {ω}_{i} T}} )}^{2} {ⅇ}^{- {ζ}_{i} {ω}_{i} t} ( 2 T - t ) & if T \leq t \leq 2 T , \\ 0 & otherwise .\end{matrix}$$

If n=3, then ƒ₃(t)=∫₀^{t}ƒ₂(t−τ)ƒ₁(τ)dτ, and the resultant shape filter with robustness order n=3 is given by

$${f}_{3} ( t ) = \{ \begin{matrix}{( \frac{{ζ}_{i} {ω}_{i}}{1 - {ⅇ}^{- {ζ}_{i} {ω}_{i} T}} )}^{3} {ⅇ}^{- {ζ}_{i} {ω}_{i} t} ( \frac{{t}^{2}}{2} ) & if 0 \leq t \leq T , \\ {( \frac{{ζ}_{i} {ω}_{i}}{1 - {ⅇ}^{- {ζ}_{i} {ω}_{i} T}} )}^{3} {ⅇ}^{- {ζ}_{i} {ω}_{i} t} ( - {t}^{2} + 3 Tt - \frac{3}{2} {T}^{2} ) & if T \leq t \leq 2 T , \\ {( \frac{{ζ}_{i} {ω}_{i}}{1 - {ⅇ}^{- {ζ}_{i} {ω}_{i} T}} )}^{3} {ⅇ}^{- {ζ}_{i} {ω}_{i} t} \frac{{( t - 3 T )}^{2}}{2} & if 2 T \leq t \leq 3 T , \\ 0 & otherwise .\end{matrix}$$

As has been discussed previously, the robustness of this profile can be furthered by the filter operation discussed previously, the price being, of course, that the time duration of the shape filter will likely be increased.

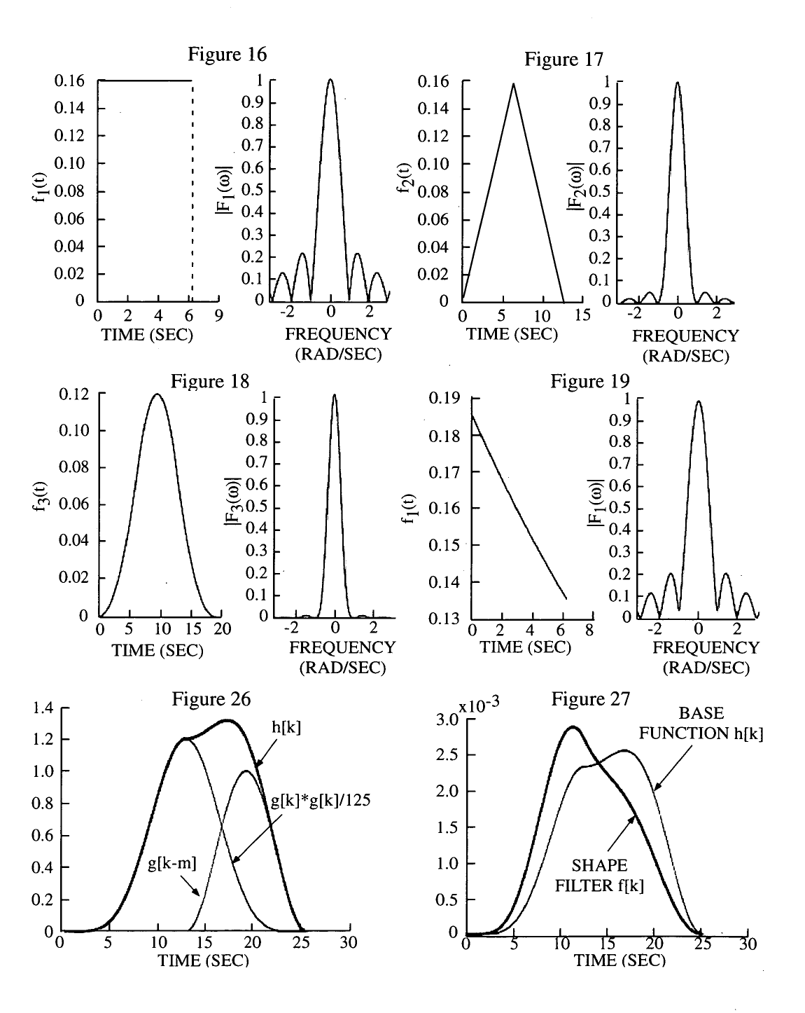

FIG. 16 shows the resultant shape filter function ƒ₁(t) in the time domain and the magnitude spectrum |F₁(ω)| in the frequency domain, with ωᵢ=1 rad/sec and ζᵢ=0. FIG. 17 shows the resultant shape filter function ƒ₂(t) and the magnitude spectrum |F₂(ω)|, with ωᵢ=1 rad/sec and ζᵢ=0. FIG. 18 shows the resultant shape filter function ƒ₃(t) and the magnitude spectrum |F₃(ω)|, with ωᵢ=1 rad/sec and ζᵢ=0.

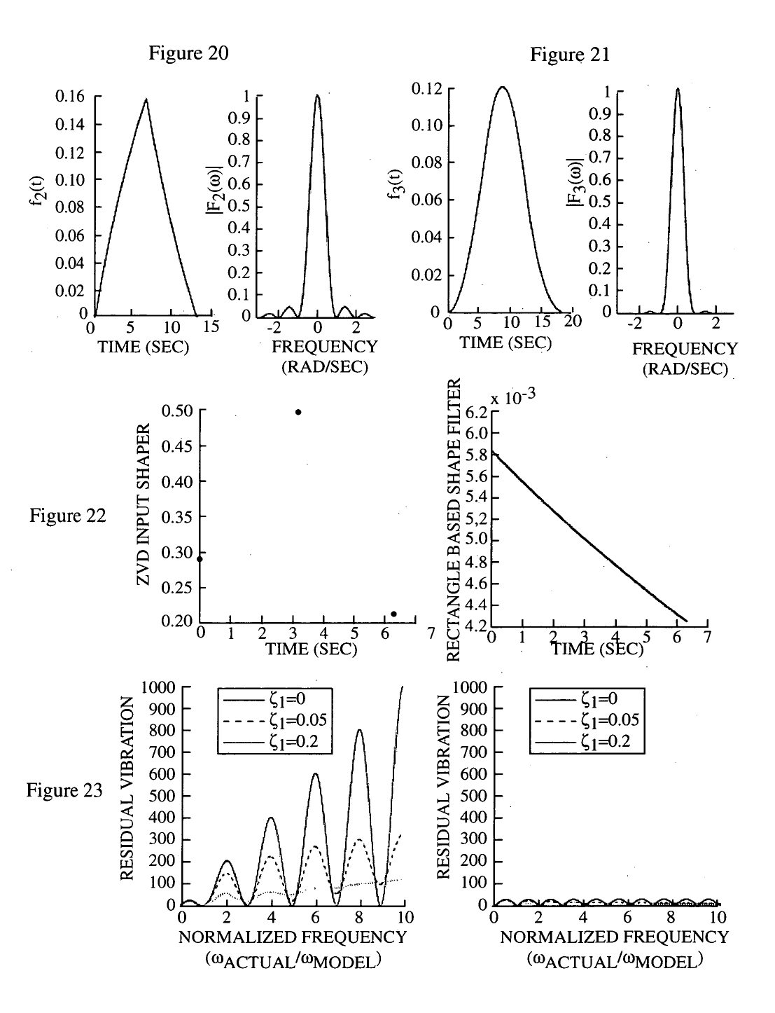

For the damped case, FIG. 19 illustrates the resultant shape filter function ƒ₁(t) in the time domain and the magnitude spectrum |F₁(ω)| in the frequency domain, with ωᵢ=1 rad/sec and ωᵢ=0.05. FIG. 20 shows the resultant shape filter function ƒ₂(t) and the magnitude spectrum |F₂(ω)|, with ωᵢ=1 rad/sec and ζᵢ=0.05. FIG. 21 shows the resultant shape filter function ƒ₃(t) and the magnitude spectrum |F₃(ω)|, with ωᵢ=1 rad/sec and ζᵢ=0.05.

As another illustrative example, a discrete-time rectangle based shape filter will be considered. Assuming that the sampling period is Tₛ sec and the total discrete-time sequence has M+1 impulses, then the rectangle function is

$$h [ k ] = \{ \begin{matrix}1 , & if 0 \leq k \leq M , \\ 0 , & otherwise .\end{matrix}$$

The discrete-time Fourier transform of h[k] is given by

$$\begin{matrix}H ( ω ) = {\sum }_{k = 0}^{M} h [ k ] {ⅇ}^{- j ω k} , \\ = {ⅇ}^{- j ω M} \frac{sin [ ω ( M + 1 ) / 2 ]}{sin ( ω / 2 )} ,\end{matrix}$$

and the magnitude spectrum of h[k] is given by

$$\vert H ( ω ) \vert = \vert \frac{sin [ ω ( M + 1 ) / 2 ]}{sin ( ω / 2 )} \vert .$$

Here the units of ω in the discrete-time Fourier transform are radians. If

$$H ( {ω}_{di} {T}_{s} ) = H ( \sqrt{1 - {ζ}_{i}^{2}} {ω}_{i} {T}_{s} ) = 0 , \\ then {ω}_{di} {T}_{s} = \frac{2 π}{M + 1} and M = \frac{2 π}{{ω}_{di} {T}_{s}} .$$

Assuming that M is a positive integer, a smooth shape filter can be generated as indicated below:

$$\begin{matrix}f [ k ] = \frac{h [ k ] / {ⅇ}^{{ζ}_{i} {ω}_{i} {kT}_{s}}}{{\sum }_{m = 0}^{M} h [ m ] / {e}^{{ζ}_{i} {ω}_{i} {mT}_{s}}} , \\ = \frac{h [ k ] / {ⅇ}^{{ζ}_{i} {ω}_{i} {kT}_{s}}}{( 1 - {ⅇ}^{- {ζ}_{i} {ω}_{i} ( M + 1 ) {T}_{s}} ) / ( 1 - {e}^{- {ζ}_{i} {ω}_{i} {T}_{s}} )} , \\ = \{ \begin{matrix}\frac{1 - {ⅇ}^{{ζ}_{i} {ω}_{i} {T}_{s}}}{1 - {ⅇ}^{- {ζ}_{i} {ω}_{i} ( M + 1 ) {T}_{s}}} {ⅇ}^{- {ζ}_{i} {ω}_{i} {kT}_{s}} & if 0 \leq k \leq M , \\ 0 & otherwise .\end{matrix}\end{matrix}$$

When ζᵢ=0, the shape filter ƒ[k] is simply equal to h[k]/(M+1). To improve robustness in the manner discussed previously, let ƒ₁[k]=ƒ[k], then ƒ₂[k]=Σₘ₌₀^{k}ƒ₁[k−m]ƒ₁[m], and the resultant shape filter with robustness order n=2 is given by

$${f}_{2} [ k ] = \{ \begin{matrix}{( \frac{1 - {ⅇ}^{{ζ}_{i} {ω}_{i} {T}_{s}}}{1 - {ⅇ}^{- {ζ}_{i} {ω}_{i} ( M + 1 ) {T}_{s}}} )}^{2} {ⅇ}^{- {ζ}_{i} {ω}_{i} {kT}_{s}} ( k + 1 ) & if 0 \leq k \leq M , \\ {( \frac{1 - {ⅇ}^{{ζ}_{i} {ω}_{i} {T}_{s}}}{1 - {ⅇ}^{- {ζ}_{i} {ω}_{i} ( M + 1 ) {T}_{s}}} )}^{2} {ⅇ}^{- {ζ}_{i} {ω}_{i} {kT}_{s}} ( 2 M + 1 - k ) & if M + 1 \leq k \leq 2 M , \\ 0 & otherwise .\end{matrix}$$

When ζᵢ=0, the resultant shape filter with robustness order n=2 is simply given by

$${f}_{2} [ k ] = \{ \begin{matrix}\frac{1}{{( M + 1 )}^{2}} ( k + 1 ) & if 0 \leq k \leq M , \\ \frac{1}{{( M + 1 )}^{2}} ( 2 M + 1 - k ) & if M + 1 \leq k \leq 2 M , \\ 0 & otherwise .\end{matrix}$$

If n=3, then ƒ₃[k]=Σₘ₌₀^{k}ƒ₂[k−m]ƒ₁[m], and the resultant shape filter with robustness order n=3 is given by

$${f}_{3} [ k ] = \{ \begin{matrix}{( \frac{1 - {ⅇ}^{- {ζ}_{i} {ω}_{i} {T}_{s}}}{1 - {ⅇ}^{- {ζ}_{i} {ω}_{i} ( M + 1 ) {T}_{s}}} )}^{3} {ⅇ}^{- {ζ}_{i} {ω}_{i} {kT}_{s}} ( k + 1 ) ( \frac{k}{2} + 2 ) & if 0 \leq k \leq M , \\ {( \frac{1 - {ⅇ}^{- {ζ}_{i} {ω}_{i} {T}_{s}}}{1 - {ⅇ}^{- {ζ}_{i} {ω}_{i} ( M + 1 ) {T}_{s}}} )}^{3} {ⅇ}^{- {ζ}_{i} {ω}_{i} {kT}_{s}} ( - \frac{3}{2} {M}^{2} + 3 Mk + \frac{3}{2} M + 1 - {k}^{2} ) & if M + 1 \leq k \leq 2 M , \\ {( \frac{1 - {ⅇ}^{- {ζ}_{i} {ω}_{i} {T}_{s}}}{1 - {ⅇ}^{- {ζ}_{i} {ω}_{i} ( M + 1 ) {T}_{s}}} )}^{3} {ⅇ}^{- {ζ}_{i} {ω}_{i} {kT}_{s}} ( 3 M + 1 - k ) \frac{( 3 M + 2 - k )}{2} & if 2 M + 1 \leq k \leq 3 M , \\ 0 & otherwise .\end{matrix}$$

The previous analysis assumes the discrete-time sequence has an exact integer number of impulses. In practice, the calculation result of

$$M = \frac{2 π}{{ω}_{di} {T}_{s}} - 1$$

may not be an integer, but a floating point number. A preferred strategy in this case is to slightly change the sampling period and to make the resultant M be an integer. That is, a new discrete-time sequence with a slightly changed sampling period will be generated. Then the new generated sequence will be replaced by a sequence having the sampling period Tₛ.

In the case of the rectangle base function, assuming that

$$M = \frac{2 π}{{ω}_{di} {T}_{s}} - 1$$

is not an integer but a floating point number. Then by choosing M₁=floor(M), the resultant new sampling period is

$${T}_{s 1} = \frac{2 π}{( {M}_{1} + 1 ) {ω}_{di}} > {T}_{s} ,$$

so the new generated base function with the sampling period Tₛ₁ is

$${h}_{1} [ k ] = \{ \begin{matrix}1 , & if 0 \leq k \leq {M}_{1} , \\ 0 & otherwise .\end{matrix}$$

Here the operator floor(x) rounds the elements of x to the nearest integer toward −∞ and the operator ceil(x) rounds the element of x to the nearest integer toward +∞. If by choosing M₂=ceil(M) the resultant new sampling period is

$${T}_{s 2} = \frac{2 π}{( {M}_{2} + 1 ) {ω}_{di}} < {T}_{s} ,$$

the new generated base function with the sampling period Tₛ₂ will be

$${h}_{2} [ k ] = \{ \begin{matrix}1 , & if 0 \leq k \leq {M}_{2} , \\ 0 & otherwise .\end{matrix}$$

To replace the base function h₁[k] of the sampling period Tₛ₁ with a base function h[k] of the sampling period Tₛ, two consecutive impulses (B₁ at nTₛ and B₂ at (n+1)Tₛ) of h[k] are calculated to replace the impulse B at kTₛ₁ of h₁[k]. Here, n is an integer satisfying the relationship

$${nT}_{s} \leq {kT}_{s 1} < ( n + 1 ) {T}_{s} , \\ or$$

$$n \leq \frac{{kT}_{s 1}}{{T}_{s}} = n + α < n + 1 ,$$

where

$$α = \frac{{kT}_{s 1}}{{T}_{s}} - n and 0 \leq α < 1.$$

The discrete-time Fourier transform of the original sequence should have the same value as the modified sequence, so
Be^{-jω(n+α)}=B₁e^{-jωn}+B₂e^{-jω(n+1)}.
Solving the above equation and yields,

$${B}_{1} = \frac{sin ( ω ( 1 - α ) )}{sin ω} B , \\ {B}_{2} = \frac{sin ( ω α )}{sin ω} B . -$$

Notice the unit of discrete-time Fourier transform variable ω is rad, then the impulses B₁ and B₂ in terms of ω_{di} rad/sec and sampling period Tₛ sec are

$${B}_{1} = \frac{sin ( {ω}_{di} {T}_{s} ( 1 - α ) )}{sin ( {ω}_{di} {T}_{s} )} B , \\ {B}_{2} = \frac{sin ( {ω}_{di} {T}_{s} α )}{sin ( {ω}_{di} {T}_{s} )} B .$$

The whole series of impulses of the modified base function h[k] can be easily generated by the following program fragment:
h[k]=0, k=0, 1, . . . ceil(M_{—}1*T_{—}s1/T_{—}s);
for k=0; k=k+1; k<=M1
n=floor(k*T_{—}s1/T_{—}s);
alpha=k*T_{—}s1/T_{—}s−n;
B=f1[k];
B1=sin(omega_{—}di*T_{—}s*(1−alpha))/sin(omega_{—}di*T_{—}s)*B;
B2=sin(omega_{—}di*T_{—}s*(alpha))/sin(omega_{—}di*T_{—}s)*B;

```
  if alpha == 0
    h[n] = h[n] + B1;
  else
    h[n] = h[n] + B1;
    h[n+1] = h[n+1] + B2;
  end
end
```

Notice the impulse at kTₛ₁ may also be replaced by two non-consecutive impulses or more than two impulses, such as impulse at (n−1)Tₛ and impulse at (n+1)Tₛ. Similarly, the modified base function of the sampling period Tₛ can also be generated from the base function h₂[k] of the sampling period Tₛ₂.

Note that the previous analysis may be readily adapated to other base functions.

As a next example, a comparison will be drawn between the discrete-time rectangle based shape filter ƒ₁[k] and the ZVD input shaping. For purposes of illustration only, a sampling period Tₛ of

$$\frac{π}{100 {ω}_{di}}$$

will be assumed. First, it should be noted that the continuous-time rectangle based shape filter ƒ₁(t) has the same time duration as the ZVD input shaper which is 2τ/ω_{di}. In discrete-time case, the time duration of the rectangle based shape filter ƒ₁[k]=ƒ[k] is

$${MT}_{s} = ( \frac{2 π}{{ω}_{di} {T}_{s}} - 1 ) {T}_{s} = \frac{2 π}{{ω}_{di}} - {T}_{s} .$$

So the time duration of discrete-time rectangle based shape filter ƒ₁[k] is always less one sample period Tₛ than the time duration of the ZVD input shaper. FIG. 22 shows the ZVD input shaper (left) and the rectangle based shape filter (right) with ωᵢ=1 rad/sec and ζᵢ=0.05. This example clearly illustrates that the amplitude of the ZVD input shaper changes abruptly. However, the rectangle based shape filter changes smoothly from the start to the end.

The residual vibration level can be plotted for ZVD input shaping and rectangle based shape filter ƒ₁[k]. In FIG. 23, the left graph shows the sensitivity curve of the ZVD input shaper with ω_{model}=1 rad/sec and different damping ζᵢ=0, 0.05, 0.2, and the right graph shows the sensitivity curve of the rectangle based shape filter ƒ₁[k] with ω_{model}=1 rad/sec and different damping ζᵢ=0, 0.05, 0.2. Although the sensitivity curve of the rectangle based shape filter at the model natural frequency ω=ω_{model}=1 rad/sec is not as flat as that of the ZVD input shaper, the high frequency unmodeled dynamics is suppressed by the smoothness of the rectangle based shape filter.

Finally, and according to still another preferred embodiment, there is provided a method of generating an asymmetric base function using methods substantially as described above. Two broad approaches will be discussed hereinafter. First, a method will be introduced wherein a shape filter will be calculated by using a combination of a base function and its derivative. Second, a shape filter using will be calculated using a combination of a base function and its self-convolution.

First, considering the derivative-based asymmetric base function, let g(t) be a base function such that G(ω_{di})=0. Then, a non-symmetric base function can be generated by the linear combination of g(t) and the derivative of g(t), such that

$$h ( t ) = {k}_{1} g ( t ) + {k}_{2} \frac{ⅆ}{ⅆ t} g ( t ) ,$$

where k₁ and k₂ are two constants. The Fourier transform of h(t) is given by

$$\begin{matrix}H ( ω ) = {\int }_{0}^{∞} h ( t ) {ⅇ}^{- jω t} ⅆ t , \\ = {\int }_{0}^{∞} [ {k}_{1} g ( t ) + {k}_{2} \frac{ⅆ}{ⅆ t} g ( t ) ] {ⅇ}^{- jω t} ⅆ t , \\ = {k}_{1 G} G ( ω ) + {k}_{2} jω G ( ω ) .\end{matrix}$$

It should be noted that the new function h(t) can be used as a base function because its spectrum H(ω) at ω=ω_{di} is, by design, exactly zero as given by

$$\begin{matrix}H ( {ω}_{di} ) = {k}_{1} G ( {ω}_{di} ) + {k}_{2} {jω}_{di} G ( {ω}_{di} ) , \\ = {k}_{1} \cdot 0 + {k}_{2} {jω}_{di} \cdot 0 , \\ = 0.\end{matrix}$$

The above derivation applies equally to discrete-time signals. Assume a discrete-time signal g[k],0≦k≦M, is a base function such that G(ω_{di}Tₛ)=0, here Tₛ is the sampling period in sec and ω_{di} is the damped natural frequency in rad/sec. Differencing g[k] in time produces

$$dg [ k ] = \{ \begin{matrix}g [ k ] - g [ k - 1 ] , & if 0 \leq k \leq M , \\ 0 , & otherwise .\end{matrix}$$

A non-symmetric base function h[k] can then be generated via a linear combination of g[k] and the differenced signal dg[k] as follows:
h[k]=k₁·g[k]+k₂·dg[k]0≦k≦M,
where k₁ and k₂ are two arbitrary constants. The discrete-time Fourier transform of h[k] is given by
H(ω)=k₁·G(ω)+k₂·(1−e^{-jω})G(ω).
So the new function h[k] is a good candidate for use as a base function because its spectrum H(ω) at ω=ω_{di}Tₛ is exactly zero as given by

$$\begin{matrix}H ( {ω}_{di} {T}_{s} ) = {k}_{1} \cdot G ( {ω}_{di} {T}_{s} ) + {k}_{2} \cdot ( 1 - {ⅇ}^{- {jω}_{di} {T}_{s}} ) G ( {ω}_{di} {T}_{s} ) , \\ = {k}_{1} \cdot 0 + {k}_{2} \cdot ( 1 - {ⅇ}^{- {jω}_{di} {T}_{s}} ) \cdot 0 , \\ = 0.\end{matrix}$$

As an example of how a non-symmetric base function might be generated in practice according to the method discussed above, consider the following example that utilizes the functional form of a Hanning window as a base function. Assume g[k] takes the functional form of a Hanning function

$$g [ k ] = \{ \begin{matrix}\frac{1}{2} - \frac{1}{2} cos ( 2 π k / M ) , & if 0 \leq k \leq M , \\ 0 , & otherwise .\end{matrix}$$

Differencing g[k] in time produces the following:

$$d g [ k ] = \{ \begin{matrix}g [ k ] - g [ k - 1 ] , & if 0 \leq k \leq M , \\ 0 , & otherwise .\end{matrix}$$

The newly generated base function is h[k]=k₁·g[k]+k₂·dg[k]. If H(ω_{di}Tₛ)=

$$H ( \sqrt{1 - {ζ}_{i}^{2}} {ω}_{i} {T}_{s} ) = 0 , then {ω}_{di} {T}_{s} = \frac{4 π}{M} and M = \frac{4 π}{{ω}_{di} {T}_{s}} .$$

Assume M is a positive integer, so a shape filter can be generated according to the following equation:

$$f [ k ] = \frac{h [ k ] / {ⅇ}^{{ζ}_{i} {ω}_{i} {kT}_{s}}}{{\sum }_{m = 0}^{M} h [ m ] / {ⅇ}^{{ζ}_{i} {ω}_{i} {mT}_{s}}} .$$

FIG. 24 shows the construction of a non-symmetric base function h[k] with the undamped natural frequency ωᵢ=1 rad/sec and the damping ratio ζᵢ=0.1. The constants k₁ and k₂ have been chosen to have the values k₁=1 and k₂=−25. FIG. 25 shows the normalized base function h[k] and the shape filter ƒ[k]. Note that these constants are arbitrary and those of ordinary skill in the art will readily be able to assign values to them depending on the system requirements.

As a final example of the foregoing, it will be instructive to consider the generation of a non-symmetric base function that has been created using a candidate base function and its self-convolution. Assume g(t) is a base function such that G(ω_{di})=0, then a non-symmetric base function can be generated by the linear combination of g(t−t₁) and g*g(t), such that
h(t)=k₁g(t−t₁)+k₂g*g(t),
where k₁ and k₂ are two constants and t₁ is a positive number. The Fourier transform of h(t) is given by

$$\begin{matrix}H ( ω ) = {\int }_{0}^{∞} h ( t ) {ⅇ}^{- jω t} ⅆ t , \\ = {\int }_{0}^{∞} [ {k}_{1} g ( t - {t}_{1} ) + {k}_{2} g * g ( t ) ] {ⅇ}^{- jω t} ⅆ t , \\ = {k}_{1} {ⅇ}^{- jω {t}_{1}} G ( ω ) + {k}_{2} {G ( ω )}^{2} .\end{matrix}$$

The resulting function h(t) is an ideal candidate for use as a base function because its spectrum H(ω) at ω=ω_{di} is exactly zero as is illustrated by the following:

$$\begin{matrix}H ( {ω}_{di} ) = {k}_{1} {ⅇ}^{- {jω}_{di} {t}_{1}} G ( {ω}_{di} ) + {k}_{2} {G ( {ω}_{di} )}^{2} , \\ = {k}_{1} {ⅇ}^{- {jω}_{di} {t}_{1}} \cdot 0 + {k}_{2} \cdot {0}^{2} , \\ = 0.\end{matrix}$$

The previous derivation applies equally to discrete-time signals via an analogous approach. Assume a discrete-time signal g[k], 0≦k≦M, is a base function such that G(ω_{di}Tₛ)=0, here Tₛ is the sampling period in sec and ω_{di} is the damped natural frequency in rad/sec. Then the self convolution of g[k] is

$$g * g [ k ] = \{ \begin{matrix}{\sum }_{m = 0}^{k} g [ k - m ] g [ m ] , & if 0 \leq k \leq 2 M , \\ 0 , & otherwise .\end{matrix}$$

The new generated base function is given by the following expression
h[k]=k₁·g[k−k₀]+k₂·g*g[k],
where k₀ is a non-negative integer. The discrete-time Fourier transform of h[k] is given by
H(ω)=k₁·e^{-jωk}^{₀}G(ω)+k₂·G(ω)².
So, the new function h[k] can be used as a base function because the spectrum H(ω) at ω=ω_{di}Tₛ is exactly zero as given by

$$\begin{matrix}H ( {ω}_{di} {T}_{s} ) = {k}_{1} \cdot {ⅇ}^{j {ω}_{di} {T}_{s} {k}_{0}} G ( {ω}_{di} {T}_{s} ) + {k}_{2} \cdot {G ( {ω}_{di} {T}_{s} )}^{2} , \\ = {k}_{1} \cdot {ⅇ}^{- {jω}_{di} {T}_{s} {k}_{0}} \cdot 0 + {k}_{2} \cdot 0 , \\ = 0.\end{matrix}$$

A simple example that illustrates the computation of a non-symmetric base function follows. Assume g[k] is a Hanning function

$$g [ k ] = \{ \begin{matrix}\frac{1}{2} - \frac{1}{2} cos ( 2 π k \text{/} M ) , & if 0 \leq k \leq M , \\ 0 , & otherwise .\end{matrix}$$

Choosing k₀=M, the new generated base function is h[k]=k₁·g[k−M]+k₂·g*g[k]. If

$$H ( {ω}_{di} {T}_{s} ) = H ( \sqrt{1 - {ζ}_{i}^{2}} {ω}_{i} {T}_{2} ) = 0 , then {ω}_{di} {T}_{s} = \frac{4 π}{M} and M = \frac{4 π}{{ω}_{di} {T}_{s}} .$$

Assume M is a positive integer, so a shape filter can be generated as

$$f [ k ] = \frac{h [ k ] / {ⅇ}^{{ζ}_{ⅈ} {ω}_{ⅈ} k {T}_{s}}}{{\sum }_{m = 0}^{M} h ( m ) / {ⅇ}^{{ζ}_{ⅈ} {ω}_{ⅈ} m {T}_{s}}} .$$

FIG. 26 shows a construction of a non-symmetric base function h[k] with the undamped natural frequency ω=1 rad/sec and the damping ratio ζᵢ=0.1. The constants k₁ and k₂ are chosen to be k₁=1 and k₂=1/125. FIG. 27 shows the normalized base function h[k] and the shape filter ƒ[k].

It should be noted and remembered that there are a number of methods of generating a non-syrnmetric base function according to the instant invention. The methods described herein are only broadly suggestive of the range of possible methods and those of ordinary skill in the art will readily be able to devise alternative ways of doing so.

Finally, and as a further examples of window functions that would be suitable for use with the instant invention, consider the following windows h(t), all of which have the property that H(ω_{di})=0 or H(ω_{di})≈0 for some choice of ω_{di}, which means that they can potentially be utilized as a base function for purposes of generating robust shape filters. The list that follows is suggestive, not exhaustive, and those of ordinary skill in the art will recognize that these window functions have traditionally been used in harmonic analysis.
cos^{α} (X) window.
Riesz window.
Riemann window.
de la Vallé-Poussin window.
Tukey window.
Bohman window.
Poisson window.
Hanning-Poisson window.
Cauchy window.
Gaussian window.
Dolph-Chebeshev window.
Kaiser-Bessel window.
Barcilon-Temes window.
Nuttall window.
Modified Bartlett-Hanning window.

### Conclusions

Finally, although the instant invention has been described herein as operating on disk drive arms, those of ordinary skill in the art will recognize that other areas of application are certainly possible. For example, the instant method could be beneficially used with the movement of robotic arms, computer controlled electromechanical devices including spacecraft (satellite), space-borne robots, general robotic arms, precision manufacturing equipment, etc.

Further, although the calculation of robust velocity and/or acceleration functions has been extensively discussed herein, that was done for purposes of specificity only and not out of any intent that the instant invention be so limited. That is, those of ordinary skill in the art will recognize the interchangeability between velocity, acceleration, jerk, position, trajectory and other profiles: given one, the others may readily be calculated. As a consequence, when calculation of a robust velocity profile is called for herein, that language should be broadly understood to mean both the literal calculation of a velocity profile, as well as the calculation of any or all of the profiles that may be calculated from it.

Still further, it should be noted that instant invention is suitable with both continuous and non-continuous base functions, as opposed to the prior art which is most suitable for use only with non-continuous functions. Of course, non-continuous functions cannot be used as a velocity profile (i.e., they are used to generate a position references defining a move from a first point to another point) and, almost without exception, contain high frequency energy in their spectra that will tend to excite high frequency resonance modes.

Additionally, the instant invention is operable with filters having both positive and negative coefficients. Of course, the use of negative coefficients may introduce unwanted harmonics into the high frequency spectrum, although in some cases it may shorten the time duration of the control profile.

Further, those of ordinary skill in the art will recognize that a robust control profile of the sort discussed herein can be directly used as a robust velocity profile, or as a robust shape filter that is further applied to an arbitrary control command. As a consequence, when the phrase robust control profile is used herein, it should be understood in the broadest to include traditional control profiles as well as shape filters that are suitable for application to other control functions.

While the invention has been described and illustrated herein by reference to a limited number of embodiments in relation to the drawings attached hereto, various changes and further modifications, apart from those shown or suggested herein, may be made therein by those skilled in the art, without exceeding the scope of what has been invented, the scope of which is to be determined only by reference to the following claims.

What is claimed is:

1. A method of moving a flexible dynamic system from an initial position to a final position, comprising the steps of:
(a) determining at least one resonance frequency of the system;
(b) selecting one of said at least one resonance frequencies;
(c) selecting a move time;
(d) selecting a base function at least according to said selected resonance frequency and said move time, wherein said base function has a spectral value approximately equal to zero at a frequency proximate to or equal to said selected resonance frequency;
(e) calculating a control profile from said base function; and,
(f) moving said flexible dynamic system from the initial position to the final position at least according to said move time and said control profile.

2. A method of moving a flexible dynamic system from an initial position to a final position according to claim 1, wherein step (b) comprises the step of:
(b1) selecting one of said at least one resonance frequencies, and,
(b2) determining a damping factor at said selected resonance frequency, and wherein step (d) comprises the step of
(d1) calculating a damped natural frequency using at least said selected resonance frequency and said damping factor at said selected resonance frequency, and,
(d2) selecting a base function at least according to said damped natural frequency and said move time, wherein said base function has a spectral value approximately equal to zero at a frequency proximate to or equal to said damped natural frequency.

3. A method of moving a flexible dynamic system from an initial position to a final position according to claim 2, wherein said damping factor at said selected resonance frequency is zero.

4. A method of moving a flexible dynamic system from an initial position to a final position according to claim 1, wherein step (d1) comprises the step of calculating a damped natural frequency at said selected resonance frequency according to the equation:
ω_{di}=\sqrt{1−ζᵢ²}ωᵢ
where ωᵢ is said selected resonance frequency, ζᵢ is said damping factor at said selected resonance frequency, and ω_{di} is said damped natural frequency.

5. A method of moving a flexible dynamic system from an initial position to a final position according to claim 1, wherein step (e) comprises the step of:
(e1) choosing a control profile to be equal to said base function.

6. A method of moving a flexible dynamic system from an initial position to a final position according to claim 1, wherein said flexible dynamic system is selected from a group consisting of a disk drive arm and a robot arm.

7. A method of moving a flexible dynamic system from an initial position to a final position according to claim 1, wherein said base function is selected from a group consisting of a rectangular window, a Hanning window, cos^{α} (X) window, a Riesz window, a Riemann window, a Riemann window, a Tukey window, a Bohman window, a Poisson window, a Hanning-Poisson window, a Cauchy window, a Gaussian window, a Dolph-Chebeshev window, a Kaiser-Bessel window, a Barcilon-Temes window, a Nuttall window, and a modified Bartlett-Hanning window.

8. A method of moving a flexible dynamic system from an initial position to a final position according to claim 1, wherein step (e) comprises the steps of:
(e1) calculating a shape filer from said base function,
(e2) selecting an arbitrary control profile,
(e3) applying said shape filter to said arbitrary control profile to produce a control profile.

9. A method of moving a flexible dynamic system from an initial position to a final position according to claim 1, wherein step (f) comprises the steps of:
(f1) performing steps (a) through (e) twice for at least two different resonance frequencies, thereby producing at least two different control profiles,
(f2) convolving together said two different control profiles, thereby producing a composite control profile, and,
(f2) moving said flexible dynamic system from the initial position to the final position at least according said composite control profile function.

10. A method of moving a flexible dynamic system from an initial position to a final position according to claim 6, wherein said flexible dynamic system is selected from a group consisting of a disk drive arm and a robot arm.

11. A method of determining a velocity profile for use in moving a flexible dynamic system from an initial position to a final position, comprising the steps of:
(a) determining at least one resonance frequency of the system;
(b) selecting one of said at least one resonance frequencies;
(c) selecting a move time;
(d) selecting a base function at least according to said selected resonance frequency and said move time, wherein said base function has a spectral value approximately equal to zero at a frequency proximate to or equal to said selected resonance frequency;
(e) calculating a control profile from said base function; and,
(f) storing in a computer readable medium at least indicia representative of said control profile for use in moving said flexible dynamic system from the initial position to the final position.

12. A method of determining a velocity profile for use in moving a flexible dynamic system from an initial position to a final position according to claim 11, comprising the further step of:
(g) reading from said computer readable medium at least said stored indicia representative of said at least one parameter values and said selected velocity profile function; and,
(h) moving the flexible dynamic system from the initial position to the final position at least according to said move time, said read indicia representative of said selected velocity profile function, and said read indicia of representative of said at least one parameter values.

13. A method according to claim 11, wherein said computer readable medium is selected from a group consisting of a magnetic disk, a magnetic tape, an optical disk, a magneto-optical disk, computer RAM, and non-volatile RAM.

14. A method of moving a flexible dynamic system from an initial position to a final position according to claim 11, wherein step (b) comprises the step of:
(b1) selecting one of said at least one resonance frequencies, and,
(b2) determining a damping factor at said selected resonance frequency, and wherein step (d) comprises the step of
(d1) calculating a damped natural frequency using at least said selected resonance frequency and said damping factor at said selected resonance frequency, and,
(d2) selecting a base function at least according to said damped natural frequency and said move time, wherein said base function has a spectral value approximately equal to zero at a frequency proximate to or equal to said damped natural frequency.

15. A method of moving a flexible dynamic system from an initial position to a final position according to claim 14, wherein said damping factor at said selected resonance frequency is zero.

16. A method of moving a flexible dynamic system from an initial position to a final position according to claim 1, wherein step (d1) comprises the step of calculating a damped natural frequency at said selected resonance frequency according to the equation:
ω_{di}=\sqrt{1−ζᵢ²}ωᵢ
where ωᵢ is said selected resonance frequency, ζᵢ is said damping factor at said selected resonance frequency, and ω_{di} is said damped natural frequency.

17. A method of moving a flexible dynamic system from an initial position to a final position according to claim 1, wherein step (e) comprises the step of:
(e1) choosing a control profile to be equal to said base function.

18. A method comprising
a step of providing a velocity control profile to describe a near time and frequency-optimal velocity profile for a control object during movement of the control object from an initial position to a final position during a predetermined move time, said control object having at least one resonance frequency, the velocity profile comprising,
a functional form characterized by having at least one Fourier transform spectral value approximately equal to zero proximate to or equal to said at least one resonance frequencies.

19. The method of claim 18, further comprising a step of moving the control object from the initial position to the final position in accordance with said velocity control profile.

20. The method of claim 18, further comprising a step of deriving from said velocity profile at least a selected one of a control voltage profile, a current profile, an acceleration profile and a displacement profile to describe an associated characteristic trajectory for the control object move from the initial position to the final position.

21. The method of claim 18, further comprising a step of utilizing the at least a selected one of said control voltage profile, current profile, acceleration profile and displacement profile to move the control object from the initial position to the final position.

22. A method of moving a flexible dynamic system from an initial position to a final position according to claim 18, wherein said control object is selected from a group consisting of a disk drive arm and a robot arm.
